(19) United States
(12) Patent Application Publication
(10) Pub. No.: US 2023/0231110 A1
(43) Pub. Date: Jul. 20, 2023

(54) CARBON-COATED LITHIATED SILICON-BASED ELECTROACTIVE MATERIALS AND METHODS OF MAKING THE SAME

(71) Applicant: GM GLOBAL TECHNOLOGY OPERATIONS LLC, Detroit, MI (US)

(72) Inventors: Mengyan HOU, Shanghai (CN); Haijing LIU, Shanghai (CN); Xiaochao QUE, Shanghai (CN); Meiyuan WU, Shanghai (CN)

(73) Assignee: GM GLOBAL TECHNOLOGY OPERATIONS LLC, Detroit, MI (US)

(21) Appl. No.: 17/882,876

(22) Filed: Aug. 8, 2022

(30) Foreign Application Priority Data
Jan. 14, 2022 (CN) 202210043878.8

(51) Int. Cl. H01M 4/36; H01M 4/38; H01M 10/0525; H01M 4/62; H01M 4/04

(52) U.S. Cl. CPC H01M 4/366; H01M 4/386; H01M 10/0525; H01M 4/625; H01M 4/0471; H01M 4/0416; H01M 2004/027

(57) ABSTRACT

Negative electrodes for electrochemical cells that cycle lithium ions are provided. The negative electrodes comprise electroactive material particles that exhibit a core-shell structure defining a core made of a lithiated silicon-based material and a shell surrounding the core that is a bi-layer structure including first and second carbon coating layers. An electrical conductivity of the first carbon coating layer is greater than that of the second carbon coating layer. A method of manufacturing a negative electrode material is provided in which a first carbon coating layer is formed on an outer surface of a silicon-based precursor particle. The silicon-based precursor particle is exposed to a lithium source to form a lithiated silicon-based particle having the first carbon coating layer. A second carbon coating layer is formed on the first carbon coating layer over the lithiated silicon-based particle to form an electroactive material particle.

### CROSS-REFERENCE TO RELATED APPLICATIONS

This application claims the benefit of Chinese Patent Application No. 202210043878.8 filed on Jan. 14, 2022. The entire disclosure of the application referenced above is incorporated herein by reference.

### INTRODUCTION

This section provides background information related to the present disclosure which is not necessarily prior art.

The present disclosure relates to negative electrodes of secondary lithium-ion batteries and, more particularly, to methods of manufacturing lithiated silicon-based electroactive materials for negative electrodes and to methods of manufacturing negative electrodes for secondary lithium-ion batteries including the lithiated silicon-based electroactive materials.

Secondary lithium-ion batteries generally include one or more electrochemical cells having a negative electrode, a positive electrode, and an ionically conductive electrolyte that provides a medium for the conduction of lithium ions through the electrochemical cell between the negative and positive electrodes. The negative and positive electrodes are electrically isolated from one another within the electrochemical cell and may be spaced apart from one another by a porous polymeric separator. At the same time, the negative and positive electrodes are electrically connected to one another outside the electrochemical cell via an external circuit. In practice, each of the negative and positive electrodes is typically deposited as a thin layer on a metallic current collector using a slurry coating process. The as-formed negative and positive electrode layers are connected to the external circuit via their respective current collectors. The negative and positive electrode materials are formulated so that, when the battery is at least partially charged, an electrochemical potential difference is established between the negative and positive electrodes within the electrochemical cell.

During battery discharge, the electrochemical potential established between the negative and positive electrodes drives spontaneous reduction-oxidation (redox) reactions within the electrochemical cell and the release of lithium ions and electrons at the negative electrode. The released lithium ions travel from the negative electrode (or anode) to the positive electrode (or cathode) through the ionically conductive electrolyte, and the electrons travel from the negative electrode to the positive electrode via the external circuit, which generates an electric current. After the negative electrode has been partially or fully depleted of lithium, the electrochemical cell may be recharged by connecting the negative and positive electrodes to an external power source, which drives nonspontaneous redox reactions within the electrochemical cell and the release of the lithium ions and the electrons from the positive electrode.

The energy density of a battery is a measurement of the amount of energy the battery can store per unit of mass and is determined collectively by the electrochemical potential difference between the negative and positive electrode materials (increasing the potential difference increases the amount of energy the battery can produce) and the specific capacity of the negative and positive electrode materials, i.e., the amount of charge that the electrode materials can store per unit of mass. In a secondary lithium-ion battery, the specific capacity of the negative and positive electrode materials corresponds to the amount of active lithium in the negative and positive electrode materials that is available to participate in the necessary redox reactions occurring within the electrochemical cells during charging and discharge of the battery. In other words, the amount of “active” lithium in the negative and positive electrode materials is the amount of lithium that can be stored in and subsequently released from the negative and positive electrode materials during repeated charging and discharge cycles of the battery.

The amount of active lithium present in a secondary lithium-ion battery after initial assembly, however, may be reduced during initial charging of the battery and during repeated cycling of the battery. For example, during the initial charge of a secondary lithium-ion battery, an electrically insulating and ionically conductive layer referred to as a solid electrolyte interphase (SEI) may inherently form in-situ on a surface of the negative electrode at an interface between the negative electrode and the electrolyte. This native SEI is believed to inherently form due to the low reduction potential of the electrochemically active material of the negative electrode, which promotes reduction of the electrolyte at the surface of the negative electrode material. However, the chemical reactions between the negative electrode material and the electrolyte that occur during formation of the SEI are believed to be parasitic and may consume active lithium, which may lead to irreversible capacity loss and may decrease the cycle life of the battery.

Silicon (Si) is a promising electrochemically active negative electrode material for secondary lithium batteries due to its low electrochemical potential (about 0.06 V vs. Li/Li⁺) and its high theoretical specific capacity (up to about 4200 mAh/g). The practical application of silicon as a negative electrode material, however, is currently limited by the amount of active lithium consumed during the initial charge of the battery due to SEI formation, as well as by the large volume changes inherently experienced by silicon-based negative electrodes during charging and discharging of the battery, e.g., up to about 300%. For example, the inherent volume changes experienced by silicon-based negative electrodes during repeated battery cycling may undermine the stability of the SEI, potentially leading to cracks or gaps in the SEI. These cracks or gaps may disrupt the electrically insulating barrier function of the SEI and may lead to further lithium-consuming chemical reactions between the electrolyte and the exposed surfaces of the silicon-based negative electrode. As such, when silicon is used as a negative electrode material in a secondary lithium-ion battery, active lithium may be continuously consumed even after initial SEI formation due to repeated exposure of the negative electrode material to the electrolyte and the inherent in-situ formation of new SEI material along exposed surfaces of the negative electrode.

To compensate for the loss of active lithium during initial charging and repeated battery cycling, a stoichiometric excess of lithium may be incorporated into electrochemical cells of secondary lithium-ion batteries.

### SUMMARY

This section provides a general summary of the disclosure and is not a comprehensive disclosure of its full scope or all of its features.

The present disclosure relates to methods of making a negative electrode material for an electrochemical cell that cycles lithium ions. In aspects, the method includes forming a first carbon coating layer on an outer surface of a silicon-based precursor particle. The silicon-based precursor particle is exposed to a lithium source to form a lithiated silicon-based particle having the first carbon coating layer. A second carbon coating layer is formed over the first carbon coating layer on the lithiated silicon-based particle to form an electroactive material particle exhibiting a core-shell structure defining a core and a shell surrounding the core. The core is defined by the lithiated silicon-based particle. The shell is a bi-layer structure defined by the first carbon coating layer and the second carbon coating layer.

The silicon-based precursor particle may exhibit a composite structure including a matrix phase and a particulate phase dispersed throughout the matrix phase. The matrix phase may comprise silicon dioxide and the particulate phase may comprise nanometer-sized silicon particles.

The silicon-based precursor particle may be substantially free of lithium.

The silicon-based precursor particle may have a D50 diameter of greater than or equal to about 1 micrometer and less than or equal to about 20 micrometers.

The first carbon coating layer may be formed on the silicon-based precursor particle via a pyrolysis process in which the silicon-based precursor particle are heated in the presence of a gaseous carbon-containing precursor compound at a temperature of greater than or equal to about 800 degrees Celsius. In aspects, the gaseous carbon-containing precursor compound may comprise at least one of a hydrocarbon or a carbohydrate.

The silicon-based precursor particle may be exposed to the lithium source by contacting the silicon-based precursor particle with a lithium-containing solution or by mixing the silicon-based precursor particle with a lithium powder to form a mixture and subjecting the mixture to a mechanical ball milling process.

The method may further comprise exposing the silicon-based precursor particle to at least one metal element selected from the group consisting of potassium (K), magnesium (Mg), sodium (Na), or calcium (Ca) to form a lithiated silicon-based particle including the at least one metal element.

The second carbon coating layer may be formed on the lithiated silicon-based particle over the first carbon coating layer using a calcination process in which the lithiated silicon-based particle is heated in the presence of a gaseous carbon-containing precursor compound at a temperature of less than or equal to about 600 degrees Celsius. In aspects, the gaseous carbon-containing precursor compound may comprise at least one of a hydrocarbon or a carbohydrate.

In aspects, a negative electrode for an electrochemical cell that cycles lithium ions is provided. The negative electrode includes an electroactive material particle exhibiting a core-shell structure defining a core and a shell surrounding the core. The core comprises a lithiated silicon-based material and the shell is a bi-layer structure including a first carbon coating layer disposed on the core and a second carbon coating layer disposed on the first carbon coating layer over the core. An electrical conductivity of the first carbon coating layer is greater than that of the second carbon coating layer.

The lithiated silicon-based material of the core may comprise a mixture of silicon, one or more silicon oxide compounds, one or more lithium silicide compounds, and one or more lithium silicate compounds.

In aspects, the lithiated silicon-based material of the core may comprise at least one element selected from the group consisting of potassium (K), magnesium (Mg), sodium (Na), or calcium (Ca). The at least one element may constitute, by weight, greater than or equal to about 5% and less than or equal to about 20% of the electroactive material particle.

The first carbon coating layer may have a thickness of greater than or equal to about 5 nanometers to less than or equal to about 300 nanometers. The second carbon coating layer may have a thickness of greater than or equal to about 1 nanometer to less than or equal to about 50 nanometers. The thickness of the second carbon coating layer may be less than the thickness of the first carbon coating layer.

The first carbon coating layer may comprise a combination of graphitic carbon and amorphous carbon, and the second carbon coating layer may consist essentially of amorphous carbon.

The electroactive material particle may comprise lithium in an amount constituting, by weight, greater than or equal to about 5% and less than or equal to about 15% of the electroactive material particle. The electroactive material particle may comprise carbon in an amount constituting, by weight, greater than or equal to about 1% and less than or equal to about 10% of the electroactive material particle.

In aspects, a negative electrode for an electrochemical cell that cycles lithium ions is provided. The negative electrode includes a mixture of electroactive material particles, electrically conductive particles, and a polymer binder. Each of the electroactive material particles exhibits a core-shell structure defining a core and a shell surrounding the core. The core of each of the electroactive material particles comprises a lithiated silicon-based material including a mixture of silicon, one or more silicon oxide compounds, one or more lithium silicide compounds, and one or more lithium silicate compounds. The shell of each of the electroactive material particles is a bi-layer structure including a first carbon coating layer disposed on the core and a second carbon coating layer disposed on the first carbon coating layer over the core. Each of the second carbon coating layers completely encapsulate the first carbon coating layer and the core on which it is disposed. A thickness of the second carbon coating layer is less than that of the first carbon coating layer. An electrical conductivity of the first carbon coating layer is greater than that of the second carbon coating layer.

The first carbon coating layer may comprise a combination of graphitic carbon and amorphous carbon, and the second carbon coating layer may consist essentially of amorphous carbon.

The electroactive material particles may comprise lithium in an amount constituting, by weight, greater than or equal to about 5% to less than or equal to about 15% of the electroactive material particles. The electroactive material particles may comprise carbon in an amount constituting, by weight, greater than or equal to about 1% to less than or equal to about 10% of the electroactive material particles.

The electroactive material particles may account for, by weight, greater than or equal to about 90% and less than or equal to about 98% of the negative electrode.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a schematic side cross-sectional view of an electrochemical cell for a secondary lithium-ion battery, wherein a negative electrode of the electrochemical cell includes electroactive material particles having a core-shell structure.

FIG. 2 is a schematic cross-sectional view of an electroactive material particle having a core-shell structure that includes a core and a shell surrounding the core, wherein the core comprises a lithiated silicon-based material and the shell exhibits a bi-layer structure including a first carbon coating layer disposed on the core and a second carbon coating layer disposed on the core over the first carbon coating layer.

FIG. 3 is a schematic cross-sectional view of a silicon-based precursor particle having a first carbon coating layer disposed on an outer surface thereof, the first carbon coating layer being formed on the outer surface of the silicon-based precursor particle via a pyrolysis process.

FIG. 4 is a schematic cross-sectional view of a lithiated silicon-based particle including a first carbon coating layer, the lithiated silicon-based particle formed by subjecting the silicon-based precursor particle and the first carbon coating layer of FIG. 3 to a lithium-doping process.

FIG. 5 is a schematic cross-sectional view of an electroactive material particle having a core-shell structure including a core and a shell surrounding the core, wherein the electroactive material particle is formed by depositing a second carbon coating layer on the lithiated silicon-based particle of FIG. 4.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated.

Example embodiments will now be described more fully with reference to the accompanying drawings.

The present disclosure relates to electroactive materials for negative electrodes of secondary lithium-ion batteries. Particles of the electroactive materials exhibit a core-shell structure defined by a core and a shell surrounding the core. The core of each electroactive material particle comprises a lithiated (or lithium-containing) silicon-based material and the shell of each electroactive material particle is a bilayer structure including a first carbon coating layer and an overlying second carbon coating layer. The electroactive material particles can be included in negative electrodes of electrochemical cells of secondary lithium-ion batteries. In such case, the lithiated silicon-based material in the core of each electroactive material particle can provide the electrochemical cells with a stoichiometric surplus of lithium in their negative electrodes prior to initial charging of the batteries.

In a method of manufacturing the electroactive material particles, a first carbon coating layer is formed at a relatively high temperature on a silicon-based precursor particle that creates a relatively thick electrically and ionically conductive barrier around the silicon-based precursor particle. After formation of the first carbon coating layer, the silicon-based precursor particle is subjected to a lithium doping process to form a lithiated silicon-based particle having the first carbon coating layer. The lithium doping process, however, may in some instances introduce cracks, imperfections, or other discontinuities into the structure of the first carbon coating layer. The second carbon coating layer is formed on the first carbon coating layer over the lithiated silicon-based particle to help make-up for structural discontinuities produced in the first carbon coating layer during the lithium doping process. In addition, the second carbon coating layer is formed at a relatively low temperature, as compared to that of the first carbon coating layer, which may provide the second carbon coating layer with certain desirable properties not exhibited by the first carbon coating layer.

Without intending to be bound by theory, it is believed that the relatively low temperature at which the second carbon coating layer is formed allows the second carbon coating layer to form a relatively thin and mechanically robust barrier around the first carbon coating layer and the lithiated silicon-based material of the core that effectively prevents undesirable chemical reactions from occurring between the electrolyte and the lithiated silicon-based material of the core. In addition, the relatively low temperature at which the second carbon coating layer is formed may allow the second carbon coating layer to more effectively accommodate the large volumetric changes experienced by the silicon-based material of the core during battery cycling while maintaining the structural integrity of the electroactive material particles. In aspects where an aqueous slurry coating process is used to deposit the electroactive material particles on surfaces of negative electrode current collectors, the first and second carbon coating layers may help prevent dissolution of lithium silicate compounds in the lithiated silicon-based material of the core during the slurry coating process.

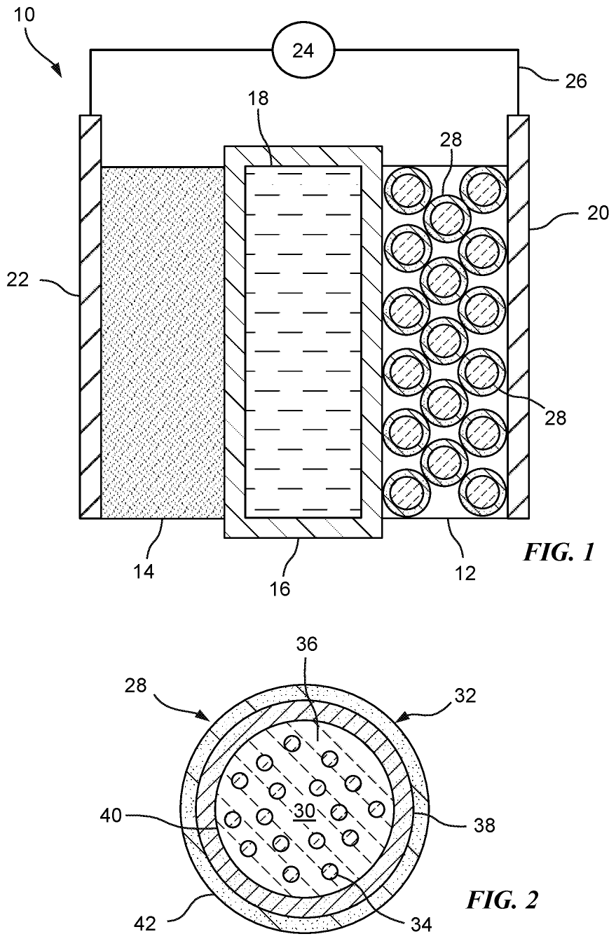

FIG. 1 depicts an electrochemical cell 10 that may be included in a battery that cycles lithium ions, such as a secondary lithium-ion battery. The electrochemical cell 10 includes a negative electrode 12, a positive electrode 14, a porous separator 16 disposed between the negative and positive electrodes 12, 14, and an ionically conductive electrolyte 18 infiltrating the negative and positive electrodes 12, 14 and the porous separator 16. The negative electrode 12 is disposed on a major surface of a negative electrode current collector 20 and the positive electrode 14 is disposed on a major surface of a positive electrode current collector 22. In practice, the negative and positive electrode current collectors 20, 22 may be electrically coupled to a load or an external power source 24 via an external circuit 26.

The electrochemical cell 10 may be used in secondary lithium-ion batteries for vehicle or automotive transportation applications (e.g., motorcycles, boats, tractors, buses, motorcycles, mobile homes, campers, and tanks), as well as in a wide variety of other industries and applications, including aerospace components, consumer products, devices, buildings (e.g., houses, offices, sheds, and warehouses), office equipment and furniture, and industrial equipment machinery, agricultural or farm equipment, or heavy machinery, by way of non-limiting example. In certain aspects, the electrochemical cell 10 may be used in secondary lithium-ion batteries for Hybrid Electric Vehicles (HEVs) and/or Electric Vehicles (EVs).

The negative and positive electrodes 12, 14 are formulated such that, when the electrochemical cell 10 is at least partially charged, an electrochemical potential difference is established between the negative and positive electrodes 12, 14. During discharge of the electrochemical cell 10, the electrochemical potential established between the negative and positive electrodes 12, 14 drives spontaneous redox reactions within the electrochemical cell 10 and the release of lithium ions and electrons at the negative electrode 12. The released lithium ions travel from the negative electrode 12 to the positive electrode 14 through the porous separator 16 and the ionically conductive electrolyte 18, and the electrons travel from the negative electrode 12 to the positive electrode 14 via the external circuit 26, which generates an electric current. After the negative electrode 12 has been partially or fully depleted of lithium, the electrochemical cell 10 may be recharged by connecting the negative and positive electrodes 12, 14 to the external power source 24, which drives nonspontaneous redox reactions within the electrochemical cell 10 and the release of the lithium ions and the electrons from the positive electrode 14. The repeated charging and discharge of the electrochemical cell 10 may be referred to herein as “cycling,” with a full charge event followed by a full discharge event being considered a full cycle.

The negative electrode 12 may be in the form of a continuous porous layer of material deposited on a major surface of the negative electrode current collector 20. The negative electrode 12 is configured to store and release lithium ions to facilitate charging and discharge, respectively, of the electrochemical cell 10. To accomplish this, the negative electrode 12 includes one or more electrochemically active (electroactive) material that can facilitate the storage and release of lithium ions by undergoing a reversible redox reaction with lithium during charge and discharge of the electrochemical cell 10. At least one of the electroactive materials of the negative electrode 12 is a silicon-based material. As an electroactive material, silicon (Si) can facilitate the storage of lithium in the negative electrode 12 during charging of the electrochemical cell 10 by forming an alloy with lithium (lithiation) and, during discharge of the electrochemical cell 10, lithium ions can be released from the negative electrode 12 by dealloying from silicon (delithiation). The term “silicon-based,” as used herein with respect to the electroactive material of the negative electrode 12, broadly includes materials in which silicon is the single largest constituent on a weight percentage (%) basis. This may include materials having, by weight, greater than 50% silicon, as well as those having, by weight, less than 50% silicon, so long as silicon is the single largest constituent of the material.

As shown in FIG. 1, prior to initial charging of the electrochemical cell 10, the negative electrode 12 includes a plurality of carbon-coated lithiated silicon-based electroactive material particles 28. The carbon-coated lithiated silicon-based electroactive material particles 28 provide the negative electrode 12 of the electrochemical cell 10 with a stoichiometric surplus of lithium prior to initial charging of the electrochemical cell 10. As shown in FIG. 2, each of the electroactive material particles 28 has a core-shell structure including a core 30 and a shell 32 disposed on and surrounding the core 30. Prior to initial charging of the electrochemical cell 10, the core 30 may account for, by weight, greater than or equal to about 90% to less than or equal to about 99% of the electroactive material particles 28, and the shell 32 may account for, by weight, greater than or equal to about 1% to less than or equal to about 10% of the electroactive material particles 28.

The core 30 of each of the electroactive material particles 28 is made of a silicon-based material and exhibits a composite structure including a including a particulate phase 34 dispersed throughout a matrix phase 36.

The particulate phase 34 of the core 30 of each electroactive material particle 28 is electrochemically active and facilitates the storage and release of lithium ions in the negative electrode 12 by undergoing a reversible redox reaction with lithium during cycling of the electrochemical cell 10. The particulate phase 34 may comprise particles of a lithium-silicon (Li—Si) alloy and/or particles of crystalline silicon (Si). The Li—Si alloy particles may comprise one or more lithium silicide compounds having a chemical composition represented by the formula LiₓSi, where x is greater than zero (0) and less than or equal to about 4.4. During charging of the electrochemical cell 10, the crystalline Si particles of the particulate phase 34 may facilitate lithium ion storage by forming an alloy with lithium (e.g., an Li—Si alloy) and, during discharge of the electrochemical cell 10, lithium ions may be released from the particulate phase 34 by dealloying from the Li—Si alloy particles and forming crystalline Si particles. Formation of the Li—Si alloy particles during lithiation of the negative electrode 12 and/or charging of the electrochemical cell 10 substantially increases the volume of the particulate phase 34, as well as the volume of the negative electrode 12.

The matrix phase 36 of the core 30 of each electroactive material particle 28 is formulated to accommodate the large volumetric changes experienced by the particulate phase 34 during cycling of the electrochemical cell 10. For example, the matrix phase 36 may be made of a substantially amorphous material and may help reduce mechanical stresses and/or avoid fracturing and/or pulverization of the electroactive material particles 28 during cycling of the electrochemical cell 10. The matrix phase 36 is a lithium-, silicon-, and oxygen-containing material. For example, the matrix phase 36 may comprise one or more lithium oxide (e.g., Li₂O), silicon oxide (e.g., SiO and/or SiO₂), and/or lithium silicate compounds of Li₂Si₂O₅, Li₂SiO₃, and/or Li₄SiO₄. In aspects, at least a portion of the lithium-containing material in the matrix phase 36 of the core 30 may be electrochemically inactive.

In aspects, the matrix phase 36 of the core 30 of each electroactive material particle 28 optionally may comprise at least one element selected from the group consisting of potassium (K), magnesium (Mg), sodium (Na), or calcium (Ca). In such case, the optional K, Mg, Na, and/or Ca may constitute, by weight, greater than or equal to about 0.1% to less than or equal to about 15% of the electroactive material particles 28.

The shell 32 of each of the electroactive material particles 28 is made of a carbon-based material and is a bi-layer structure including a first carbon coating layer 38 disposed on an outer surface 40 of the core 30 and a second carbon coating layer 42 disposed on the first carbon coating layer 38 over the core 30.

The first carbon coating layer 38 is formulated to provide the electroactive material particles 28 with improved electrical conductivity to provide the negative electrode 12 with increased discharge and charge rate capabilities. The first carbon coating layer 38 may at least partially surround the core 30 and thus may form a barrier that inhibits direct exposure between the electroactive material of the core 30 and the electrolyte 18 that infiltrates the porous structure of the negative electrode 12.

In aspects, the first carbon coating layer 38 may consist essentially of carbon (C). The first carbon coating layer 38 may have a thickness of greater than or equal to about 5 nanometers to less than or equal to about 300 nanometers.

The second carbon coating layer 42 may be in the form of a substantially continuous layer of material that completely encapsulates the core 30 and the first carbon coating layer 38. As such, the second carbon coating layer 42 may provide a robust physical barrier around the core 30 that effectively prevents contact between the electroactive material of the core 30 and the electrolyte 18 that infiltrates the porous structure of the negative electrode 12. The second carbon coating layer 42 may have has a thickness of greater than or equal to about 1 nanometer to less than or equal to about 50 nanometers.

The thickness of the first carbon coating layer 38 may be greater than that of the second carbon coating layer 42. In addition, the electrical conductivity of the first carbon coating layer 38 may be greater than that of the second carbon coating layer 42.

Both the first carbon coating layer 38 and the second carbon coating layer 42 may have a Raman spectrum that exhibits notable peaks at about 1580 reciprocal centimeters (cm⁻¹), referred to as the “G” band, and at about 1300 cm⁻¹, referred to as the “D” band. The intensity of the G band peak exhibited by a carbon material is generally interpreted as an indication of the amount of sp² hybridized carbon bonds in the material, which are generally associated with the presence crystalline graphitic carbon. The presence of a D band in the Raman spectrum of a carbon material is generally interpreted as indicative of the presence of a disordered carbon network and the presence of sp^{a} hybridized carbon bonds in the material, with the intensity of the D band being related to the disordered state of the material. For a carbon material, a ratio of the intensity of the G band peak (I_{G}) relative to the intensity of the D band peak (ID) may provide an indication of the relative amount of crystalline graphitic carbon in the material. In aspects, the ratio I_{G}/ID for the first carbon coating layer 38 may be greater than the ratio IG/ID for the second carbon coating layer 42.

Prior to initial charging of the electrochemical cell 10, the electroactive material particles 28 may have a lithium content that accounts for, by weight, greater than or equal to about 5% to less than or equal to about 15% of the electroactive material particles 28 and a carbon content that accounts for, by weight, greater than or equal to about 1% to less than or equal to about 10% of the electroactive material particles 28.

The negative electrode 12 optionally may include particles of an electrically conductive material (not shown), which may help facilitate transport of electrons between the electroactive material particles 28 and the negative electrode current collector 20 during cycling of the electrochemical cell 10. The optional electrically conductive particles of the negative electrode 12 may comprise particles of a carbon-based material, metal particles (e.g., powdered nickel), and/or an electrically conductive polymer. Examples of electrically conductive carbon-based materials include carbon black (e.g., acetylene black), graphite, graphene (e.g., graphene nanoplatelets), carbon nanotubes (e.g., single-walled carbon nanotubes), and/or carbon fibers (e.g., carbon nanofibers). Examples of electrically conductive polymers include polyaniline, polythiophene, polyacetylene, and/or polypyrrole. The optional electrically conductive particles of the negative electrode 12 may have a mean particle diameter in a range of 2 nanometers to 20 micrometers and may account for, by weight, greater than 0% to less than 20% of the negative electrode 12.

In aspects, the electroactive material particles 28 and the optional electrically conductive particles may be intermingled with a polymer binder in the negative electrode 12. The polymer binder may provide the negative electrode 12 with structural support and may promote cohesion between the electroactive material particles 28 and the optional electrically conductive particles in the negative electrode 12. Examples of polymer binders that may be used in the negative electrode 12 include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), polyacrylates, alginates, polyacrylic acid (PAA), and combinations thereof.

The electroactive material particles 28 may account for, by weight, greater than or equal to about 90% to less than or equal to about 98% of the negative electrode 12.

The positive electrode 14 may be in the form of a continuous porous layer of material and may include one or more electrochemically active materials that can undergo a reversible redox reaction with lithium at a higher electrochemical potential than the electrochemically active material of the negative electrode 12 such that an electrochemical potential difference exists between the negative and positive electrodes 12, 14. For example, the positive electrode 14 may comprise a material that can undergo lithium intercalation and deintercalation, alloying and dealloying, or plating and stripping. In aspects, the positive electrode 14 may comprise an intercalation host material that can undergo the reversible insertion or intercalation of lithium ions. In such case, the intercalation host material of the positive electrode 14 may comprise a layered oxide represented by the formula LiMeO₂, an olivine-type oxide represented by the formula LiMePO₄, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In further aspects, the positive electrode 14 may comprise a conversion material including a component that can undergo a reversible electrochemical reaction with lithium, in which the component undergoes a phase change or a change in crystalline structure accompanied by a change in oxidation state. In such case, the conversion material of the positive electrode 14 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof. Examples of metals for inclusion in the conversion material of the positive electrode 14 include iron, manganese, nickel, copper, and cobalt.

The electrochemically active material of the positive electrode 14 may be a particulate material and particles of the electrochemically active material of the positive electrode 14 may be intermingled with a polymer binder to provide the positive electrode 14 with structural integrity. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), polyacrylates, alginates, polyacrylic acid, and mixtures thereof. The positive electrode 14 optionally may include particles of an electrically conductive material. Examples of electrically conductive materials include carbon-based materials, metals (e.g., nickel), and/or electrically conductive polymers. Examples of electrically conductive carbon-based materials include carbon black (e.g., acetylene black), graphite, graphene (e.g., graphene nanoplatelets), carbon nanotubes, and/or carbon fibers (e.g., carbon nanofibers). Examples of electrically conductive polymers include polyaniline, polythiophene, polyacetylene, and/or polypyrrole.

The porous separator 16 electrically isolates the positive and negative electrodes 12, 14 from each other and may be in the form of a microporous ionically conductive and electrically insulating film or non-woven material, e.g., a manufactured sheet, web, or matt of directionally or randomly oriented fibers. In aspects, the porous separator 16 may comprise a microporous polymeric material, e.g., a microporous polyolefin-based membrane or film. For example, the porous separator 16 may comprise a single polyolefin or a combination of polyolefins, such as polyethylene (PE), polypropylene (PP), polyamide (PA), poly(tetrafluoroethylene) (PTFE), polyvinylidene fluoride (PVdF), and/or poly(vinyl chloride) (PVC). In certain aspects, the porous separator 16 may comprise a laminate of one or more polymeric materials, such as a laminate of PE and PP.

The electrolyte 18 provides a medium for the conduction of lithium ions through the electrochemical cell 10 between the positive and negative electrodes 12, 14 and may be in the form of a liquid, solid, or gel. In aspects, the electrolyte 18 may comprise a nonaqueous liquid electrolyte solution including one or more lithium salts dissolved in a nonaqueous aprotic organic solvent or a mixture of nonaqueous aprotic organic solvents. Examples of lithium salts include lithium hexafluorophosphate (LiPF₆), lithium perchlorate (LiClO₄), lithium tetrachloroaluminate (LiAlCl₄), lithium iodide (Lil), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. Examples of nonaqueous aprotic organic solvents include alkyl carbonates, for example, cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof. In aspects where the electrolyte 18 is in the form of a solid, the electrolyte 18 may function as both an electrolyte and a separator and may eliminate the need for a discreate separator 16.

The negative and positive electrode current collectors 20, 22 are electrically conductive and provide an electrical connection between the external circuit 26 and their respective negative and positive electrodes 12, 14. In aspects, the negative and positive electrode current collectors 20, 22 may be in the form of nonporous metal foils, perforated metal foils, porous metal meshes, or a combination thereof. The negative electrode current collector 20 may be made of copper, nickel, or alloys thereof, stainless steel, or other appropriate electrically conductive material. The positive electrode current collector 22 may be made of aluminum (Al) or another appropriate electrically conductive material.

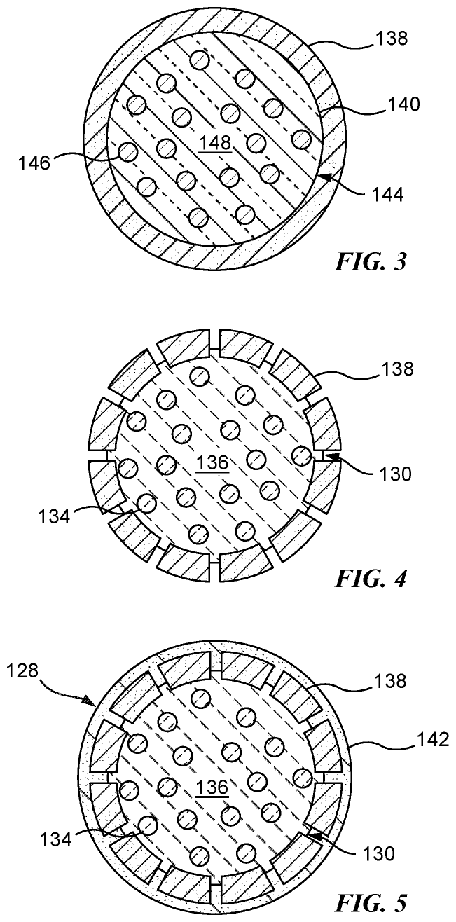

Referring now to FIGS. 3, 4, and 5, carbon-coated lithiated silicon-based electroactive material particles 128 (FIG. 5) may be manufactured via a method that includes one or more of the following steps. The electroactive material particles 128 are similar in many respects to the carbon-coated lithiated silicon-based electroactive material particles 28 discussed above with respect to FIGS. 1 and 2 and description of common subject matter may not be repeated here.

In a first step, a plurality of silicon-based precursor particles 144 may be provided. The silicon-based precursor particles 144 may exhibit a composite structure including a particulate phase 146 dispersed through a matrix phase 148. The particulate phase 146 may comprise particles of crystalline and/or amorphous silicon (Si) having diameters of greater than or equal to 2 nanometers and less than or equal to 15 nanometers. The matrix phase 148 may comprise a silicon oxide (SiOₓ)-based material. For example, the matrix phase 148 may comprise a mixture of silicon dioxide (SiO₂) and optionally one or more silicon sub-oxides represented by the formula SiO_{y}, where y is less than 2. The overall composition of the silicon-based precursor particles 144 may be represented by the formula SiOₓ, wherein xis greater than or equal to 0.8 and less than or equal to 1.3. The silicon-based precursor particles 144 may be substantially free of lithium. For example, the silicon-based precursor particles 144 may comprise, by weight, less than 1.0% or less than 0.1% lithium. The silicon-based precursor particles 144 may have a D50 diameter of greater than or equal to about 1 micrometer to less than or equal to about 20 micrometers. In aspects, the silicon-based precursor particles 144 may have a D50 diameter of greater than or equal to about 3 micrometers to less than or equal to about 10 micrometers. In some aspects, the silicon-based precursor particles 144 may have a D50 diameter of greater than or equal to about 4 micrometers to less than or equal to about 6 micrometers.

As shown in FIG. 3, a first carbon coating layer 138 may be deposited on outer surfaces 140 of the silicon-based precursor particles 144 in a second step. The first carbon coating layer 138 may be deposited on outer surfaces 140 of the silicon-based precursor particles 144 using a pyrolysis process. In such process, the silicon-based precursor particles 144 may be heated in an enclosed chamber in the presence of a gaseous carbon-containing precursor compound at a temperature of greater than or equal to about 800 degrees Celsius (° C.) to less than or equal to about 1200° C. for a duration of greater than or equal to about 30 minutes to less than or equal to about 600 minutes. The pyrolysis process may be performed in an inert gas environment, e.g., of nitrogen, argon, and/or helium. During the pyrolysis process, the gaseous carbon-containing precursor compound may thermally decompose and deposit a layer of carbon-containing or carbonaceous material on the on the outer surfaces 140 of the silicon-based precursor particles 144. The gaseous carbon-containing precursor compound may comprise a hydrocarbon (e.g., an aliphatic or aromatic C2—C10 hydrocarbon) or a carbohydrate (i.e., a chemical compound consisting of carbon (C), hydrogen (H) and oxygen (O) atoms). Examples of gaseous hydrocarbons include methane (CH₄), ethane (C₂H₆), ethylene (C₂H₄), propane (C₃H₈), butane (C₄H₁₀), pentane (C₅H₁₂), hexane (C₆H₁₄), heptane (C₇H₁₆), octane (C₈H₁₈), acetylene (C₂H₂), toluene (C₇H₈), and/or natural gas. Examples of carbohydrates include sucrose and/or glucose.

The first carbon coating layer 138 may comprise a combination of graphitic carbon and amorphous carbon. The pyrolysis process is performed at a temperature of greater than or equal to about 800° C., which may promote the formation of sp² hybridized carbon bonds in the first carbon coating layer 138, instead of the formation of sp³ hybridized carbon bonds. As such, a ratio of sp² carbon bonds to sp³ carbon bonds in the first carbon coating layer 138 may be greater than one (1). The first carbon coating layer 138 may comprise a relatively high concentration of graphitic carbon and may exhibit relatively high electrical conductivity (as compared to the second carbon coating layer 142).

Referring now to FIG. 4, a metal doping process may be performed to introduce a desirable amount of lithium into the composite structure of the silicon-based precursor particles 144 and to transform the silicon-based precursor particles 144 into lithiated silicon-based particles 130. The process of introducing lithium into the composite structure of the silicon-based precursor particles 144 may be referred to as a lithium doping process. Like the core 30 of each of the electroactive material particles 28, the lithiated silicon-based particles 130 exhibit a composite structure including a including a particulate phase 134 dispersed throughout a matrix phase 136. The particulate phase 134 may comprise particles of a lithium-silicon (Li—Si) alloy and/or particles of crystalline and/or amorphous silicon (Si), and the matrix phase 136 may comprise an amorphous lithium-, silicon-, and oxygen-containing material. For example, the amorphous lithium-, silicon-, and oxygen-containing material of the matrix phase 136 may include a mixture of one or more lithium silicates (e.g., Li₂Si₂O₅, Li₂SiO₃, and/or Li₄SiO₄). In aspects, the amorphous lithium-, silicon-, and oxygen-containing material of the matrix phase 136 may include one or more silicon oxides (e.g., SiO and/or SiO₂), and/or lithium oxide (e.g., Li₂O).

The lithium doping process may be performed by contacting the silicon-based precursor particles 144 with a lithium source in liquid or solid phase. In aspects where the lithium source is in liquid phase, the lithium source may comprise a solution of a lithium salt dissolved or dispersed in a nonaqueous organic solvent and the silicon-based precursor particles 144 may be placed in contact with the lithium salt-containing solution, for example, by immersing the silicon-based precursor particles 144 in the solution. In aspects where the lithium source is in solid phase, the lithium source may comprise a lithium-containing powder and the silicon-based precursor particles 144 may be placed in contact with the lithium-containing powder, for example, by ball milling a mixture of the silicon-based precursor particles 144 and the lithium-containing powder.

In aspects, the metal doping process may include introducing one or more one group IA alkali metals or group IIA alkaline earth metals into the matrix phase 148 of the silicon-based precursor particles 144. In aspects, the matrix phase 148 of the silicon-based precursor particles 144 may be doped with one or more elements of potassium (K), magnesium (Mg), sodium (Na), or calcium (Ca). In aspects, the silicon-based precursor particles 144 may be doped with one or more of K, Mg, Na, or Ca in the same step as the lithium doping process or in a separate step. For example, in aspects where the lithium source is in liquid phase, one or more salts of K, Mg, Na, and/or Ca may be dissolved or dispersed in the lithium-containing solution prior to contacting the silicon-based precursor particles 144 with the solution. In aspects where the lithium source is in solid phase, the lithium-containing powder may be mixed with particles of K, Mg, Na, and/or Ca prior to the ball milling process.

As shown in FIG. 4, the metal doping process may introduce cracks, imperfections, or discontinuities into the structure of the first carbon coating layer 138, which may, in assembly, allow the electrolyte 18 to penetrate the first carbon coating layer 138 and contact the lithiated silicon-based particles 130. It may be desirable to prevent undesirable lithium-consuming chemical reactions from occurring between the lithiated silicon-based particles 130 and the electrolyte 18 during initial charging and repeated cycling of the electrochemical cell 10, as such chemical reactions may consume active lithium and reduce the capacity of the electrochemical cell 10.

Referring now to FIG. 5, a second carbon coating layer 142 may be deposited on the lithiated silicon-based particles 130 over the first carbon coating layer 138 using a calcination process. In such process, the lithiated silicon-based particles 130 may be heated in an enclosed chamber in the presence of a gaseous carbon-containing precursor compound at a temperature of greater than or equal to about 300° C. to less than or equal to about 600° C. for a duration of greater than or equal to about 30 minutes to less than or equal to about 600 minutes. The calcination process may be performed in an inert gas environment, e.g., of nitrogen, argon, and/or helium. During the calcination process, the gaseous carbon-containing precursor compound may thermally decompose and deposit a layer of carbon-containing or carbonaceous material on the lithiated silicon-based particles 130 over the first carbon coating layer 138. The gaseous carbon-containing precursor compound may comprise a hydrocarbon (e.g., an aliphatic or aromatic C2-C10 hydrocarbon) or a carbohydrate (i.e., a chemical compound consisting of carbon (C), hydrogen (H) and oxygen (O) atoms). Examples of gaseous hydrocarbons include methane (CH₄), ethane (C₂H₆), ethylene (C₂H₄), propane (C₃H₈), butane (C₄H₁₀), pentane (C₅H₁₂), hexane (C₆H₁₄), heptane (C₇H₁₆), octane (C₈H₁₈), acetylene (C₂H₂), toluene (C₇H₈), and/or natural gas. Examples of carbohydrates include sucrose and/or glucose.

The second carbon coating layer 142 may comprise a combination of graphitic carbon and amorphous carbon. In aspects, the second carbon coating layer 142 may comprise an amorphous carbon that generally lacks any crystalline structure or ordering or graphitic carbon. The calcination process is performed at a temperature of less than or equal to 600° C., which may promote the formation of sp³ hybridized carbon bonds in the second carbon coating layer 142, instead of the formation of sp² hybridized carbon bonds. The second carbon coating layer 142 may comprise a relatively high concentration of amorphous carbon and may exhibit greater mechanical flexibility (as compared to the first carbon coating layer 138), which may allow the second carbon coating layer 142 to accommodate the volumetric changes experienced by the electroactive material particles 28, 128 during cycling of the electrochemical cell 10 while maintaining a robust physical barrier between the lithiated silicon-based particles 130 and the electrolyte 18.

The as-formed second carbon coating layer 142 may fill-in cracks, gaps, imperfections, or other discontinuities in the structure of the first carbon coating layer 138 and may form a substantially continuous layer of material around the lithiated silicon-based particles 130 and the first carbon coating layer 138 that completely encapsulates the lithiated silicon-based particles 130 and the first carbon coating layer 138. As such, the second carbon coating layer 142 may provide a robust physical barrier around the lithiated silicon-based particles 130 that prevents undesirable chemical reactions from occurring between the lithiated silicon-based particles 130 and the electrolyte 18 during initial charging and repeated cycling of the electrochemical cell 10.

The foregoing description of the embodiments has been provided for purposes of illustration and description. It is not intended to be exhaustive or to limit the disclosure. Individual elements or features of a particular embodiment are generally not limited to that embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a negative electrode material for an electrochemical cell that cycles lithium ions, the method comprising:
forming a first carbon coating layer on an outer surface of a silicon-based precursor particle;
exposing the silicon-based precursor particle to a lithium source to form a lithiated silicon-based particle having the first carbon coating layer; and
forming a second carbon coating layer over the first carbon coating layer on the lithiated silicon-based particle to form an electroactive material particle exhibiting a core-shell structure defining a core and a shell surrounding the core, wherein the core is defined by the lithiated silicon-based particle, and the shell is a bi-layer structure defined by the first carbon coating layer and the second carbon coating layer.

2. The method of claim 1, wherein the silicon-based precursor particle exhibits a composite structure including a matrix phase and a particulate phase dispersed throughout the matrix phase, wherein the matrix phase comprises silicon dioxide and the particulate phase comprises nanometer-sized silicon particles.

3. The method of claim 1, wherein the silicon-based precursor particle is substantially free of lithium.

4. The method of claim 1, wherein the silicon-based precursor particle has a D50 diameter of greater than or equal to about 1 micrometer and less than or equal to about 20 micrometers.

5. The method of claim 1, wherein the first carbon coating layer is formed on the silicon-based precursor particle via a pyrolysis process in which the silicon-based precursor particle is heated in the presence of a gaseous carbon-containing precursor compound at a temperature of greater than or equal to about 800 degrees Celsius.

6. The method of claim 5, wherein the gaseous carbon-containing precursor compound comprises at least one of a hydrocarbon or a carbohydrate.

7. The method of claim 1, wherein the silicon-based precursor particle is exposed to the lithium source by contacting the silicon-based precursor particle with a lithium-containing solution or by mixing the silicon-based precursor particle with a lithium powder to form a mixture and subjecting the mixture to a mechanical ball milling process.

8. The method of claim 1, further comprising:
exposing the silicon-based precursor particle to at least one metal element selected from the group consisting of potassium (K), magnesium (Mg), sodium (Na), or calcium (Ca) to form a lithiated silicon-based particle including the at least one metal element.

9. The method of claim 1, wherein the second carbon coating layer is formed on the lithiated silicon-based particle over the first carbon coating layer using a calcination process in which the lithiated silicon-based particle is heated in the presence of a gaseous carbon-containing precursor compound at a temperature of less than or equal to about 600 degrees Celsius.

10. The method of claim 9, wherein the gaseous carbon-containing precursor compound comprises at least one of a hydrocarbon or a carbohydrate.

11. A negative electrode for an electrochemical cell that cycles lithium ions, the negative electrode comprising:
an electroactive material particle exhibiting a core-shell structure defining a core and a shell surrounding the core,
wherein the core comprises a lithiated silicon-based material,
wherein the shell is a bi-layer structure including a first carbon coating layer disposed on the core and a second carbon coating layer disposed on the first carbon coating layer over the core, and
wherein an electrical conductivity of the first carbon coating layer is greater than that of the second carbon coating layer.

12. The negative electrode of claim 11, wherein the lithiated silicon-based material of the core comprises a mixture of silicon, one or more silicon oxide compounds, one or more lithium silicide compounds, and one or more lithium silicate compounds.

13. The negative electrode of claim 12, wherein the lithiated silicon-based material of the core comprises at least one element selected from the group consisting of potassium (K), magnesium (Mg), sodium (Na), or calcium (Ca), and wherein the at least one element constitutes, by weight, greater than or equal to about 5% and less than or equal to about 20% of the electroactive material particle.

14. The negative electrode of claim 11, wherein the first carbon coating layer has a thickness of greater than or equal to about 5 nanometers to less than or equal to about 300 nanometers, the second carbon coating layer has a thickness of greater than or equal to about 1 nanometer and less than or equal to about 50 nanometers, and wherein the thickness of the second carbon coating layer is less than the thickness of the first carbon coating layer.

15. The negative electrode of claim 11, wherein the first carbon coating layer comprises a combination of graphitic carbon and amorphous carbon and the second carbon coating layer consists essentially of amorphous carbon.

16. The negative electrode of claim 11, wherein the electroactive material particle comprises lithium in an amount constituting, by weight, greater than or equal to about 5% and less than or equal to about 15% of the electroactive material particle, and wherein the electroactive material particle comprises carbon in an amount constituting, by weight, greater than or equal to about 1% and less than or equal to about 10% of the electroactive material particle.

17. A negative electrode for an electrochemical cell that cycles lithium ions, the negative electrode comprising:
a mixture of electroactive material particles, electrically conductive particles, and a polymer binder, wherein each of the electroactive material particles exhibits a core-shell structure defining a core and a shell surrounding the core,
wherein the core of each of the electroactive material particles comprises a lithiated silicon-based material including a mixture of silicon, one or more silicon oxide compounds, one or more lithium silicide compounds, and one or more lithium silicate compounds,
wherein the shell of each of the electroactive material particles is a bi-layer structure including a first carbon coating layer disposed on the core and a second carbon coating layer disposed on the first carbon coating layer over the core,
wherein each of the second carbon coating layers completely encapsulates the first carbon coating layer and the core on which it is disposed, and
wherein a thickness of the second carbon coating layer is less than that of the first carbon coating layer and an electrical conductivity of the first carbon coating layer is greater than that of the second carbon coating layer.

18. The negative electrode of claim 17, wherein the first carbon coating layer comprises a combination of graphitic carbon and amorphous carbon and the second carbon coating layer consists essentially of amorphous carbon.

19. The negative electrode of claim 17, wherein the electroactive material particles comprise lithium in an amount constituting, by weight, greater than or equal to about 5% to less than or equal to about 15% of the electroactive material particles, and wherein the electroactive material particles comprise carbon in an amount constituting, by weight, greater than or equal to about 1% to less than or equal to about 10% of the electroactive material particles.

20. The negative electrode of claim 17, wherein the electroactive material particles account for, by weight, greater than or equal to about 90% and less than or equal to about 98% of the negative electrode.
